(19) United States
(12) Patent Application Publication
(10) Pub. No.: US 2025/0118219 A1
(43) Pub. Date: Apr. 10, 2025

(54) Educational Interactive Teaching Apparatus For Literacy Development And Teaching Phonics

(71) Applicant: Modupe Mary Famodimu, Prosper, TX (US)

(72) Inventor: Modupe Mary Famodimu, Prosper, TX (US)

(21) Appl. No.: 18/983,392

(22) Filed: Dec. 17, 2024

(51) Int. Cl. G09B 5/04; G09B 19/00

(52) U.S. Cl. CPC G09B 5/04; G09B 19/00

(57) ABSTRACT

An educational interactive teaching apparatus comprises a body, a plurality of interactive buttons, an audio unit, a power switch, a control unit, and an on-broad power unit. The educational interactive teaching apparatus offers several advantages that enhance both the learning experience and the sustainability of its design. The use of biodegradable, eco-friendly materials such as wood and cork ensure the educational interactive teaching apparatus is both durable and environmentally responsible. The educational interactive teaching apparatus engages children in learning phonics, sight words, and word family sounds in a natural and screen-free environment. Upon pressing an interactive button, the educational interactive teaching apparatus produces the correct phonetic sound associated with the selected word or alphabets.

### FIELD OF INVENTION

The present disclosure relates generally to educational tools and devices, and more particularly to an eco-friendly and sustainable educational interactive teaching apparatus that facilitates learning of phonetic sounds, sight words, and word families.

### BACKGROUND

Learning phonics is a foundational skill in early childhood education, crucial for developing reading, writing, and spelling abilities. Phonics instruction involves teaching the relationships between letters and sounds, enabling children to decode words and build literacy skills. However, with the increasing availability of digital devices, children are often drawn to screen-based activities, which can hinder their focus on interactive, hands-on learning methods. The need for an engaging, screen-free, and eco-friendly educational tool has become more important than ever.

One significant challenge in modern education is children's over-reliance on television, computers, and mobile devices. These screen-based solutions, while sometimes educational, can lead to decreased attention spans, overexposure to digital media, and limited tactile or interactive learning experiences. This reliance often detracts from the critical development of hands-on exploration and self-directed learning, particularly in foundational subjects like phonics. Additionally, many families and educators seek eco-conscious alternatives to reduce the environmental impact of plastic and electronic waste associated with typical educational toys.

Several technologies and tools currently aim to teach phonics and support literacy development. Devices such as tablets or plastic-based phonics toys provide visual and auditory feedback to teach letters, words, and phonics sounds. Mobile apps offer interactive lessons and games to teach phonics in a digital format. Alphabet puzzles that emit sounds when pieces are correctly placed are commonly used in schools and homes. Battery-operated books with sound buttons allow children to hear phonics sounds associated with specific words or letters. Laminated cards, magnetic letters, and tactile materials are also employed in classrooms to aid in phonics instruction.

However, software applications are effective but contribute to prolonged screen time, potentially causing negative effects such as eye strain, reduced focus, and over-reliance on digital devices. Traditional tools like laminated cards or magnetic letters lack interactive features such as sound feedback, making them less engaging for children. Plastic toys and puzzles often wear out or break over time, especially in the hands of young children, leading to frequent replacements. Few existing technologies offer inclusive features for children with visual or auditory impairments, limiting their usability across diverse learning needs.

Hence, traditional phonics teaching aids, such as flashcards, books, and puzzles, often lack the dynamic and interactive qualities needed to maintain a child's attention. On the other hand, advanced electronic learning toys are typically made of plastic, contributing to environmental concerns, or rely heavily on flashy visual elements, inadvertently encouraging a dependence on screen-like stimuli.

Therefore, there is a need an eco-friendly and sustainable educational interactive teaching apparatus that facilitates learning of phonetic sounds, sight words, and word families. There is need for an educational interactive teaching apparatus that provides a screen-free operation and offers an engaging alternative that supports self-directed learning while reducing reliance on digital devices.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to an eco-friendly and sustainable educational interactive teaching apparatus that facilitates learning of phonetic sounds, sight words, and word families.

An embodiment of a first aspect, an educational interactive teaching apparatus comprises a body, a plurality of interactive buttons, an audio unit, a power switch, a control unit, and an on-broad power unit.

In one embodiment, the body is made of a biodegradable, strong, and eco-friendly material that comprises at least one of a wood, and cork. In one embodiment, the body is made of a material includes at least one of natural rubberwood, plastic, vinyl, fiber-glass, glass, and paperboard.

In one embodiment, the interactive buttons are positioned on a top surface of the body. Each interactive button is adapted to indicate at least one of an alphabet, a sight word, a sight word, blends, digraphs, and a phonetic group, catering to various learning levels and objectives. The representation of each alphabet on the interactive buttons are implemented through printing, embossing, or engraving, offering flexibility in design while enhancing the tactile or visual experience.

In one embodiment, the audio unit is operatively connected to the interactive buttons. The audio unit is configured to generate an auditory output corresponding to a phonetic sound of a selected alphabet, a selected sight word, or a selected phoneme when at least one interactive button associated with the selected alphabet is pressed.

In one embodiment, the audio unit includes, but is not limited to, a speaker, which provides clear and precise sound output. This design enhances the educational experience by reinforcing phonetic associations through audible cues, making the learning process more engaging and effective.

In one embodiment, the power switch is configured to control the activation and deactivation of the educational interactive teaching apparatus.

In one embodiment, the control unit is in communication with the audio unit and the plurality of interactive buttons. When a user presses at least one interactive button, the control unit activates the audio unit to generate the corresponding auditory output, such as the phonetic sound of the selected alphabet or sight word. Additionally, the control unit is configured to detect when the user presses and holds an interactive button. This extended press triggers the generation of sound combinations, such as blends of vowels and consonants, corresponding to the selected alphabet or phonetic group. This functionality enables more complex phonics and word-building exercises, enhancing the learning experience by facilitating the practice of word blending and phonemic awareness.

In another embodiment, the control unit is in communication with the audio unit and the plurality of interactive buttons through a communication path.

In one embodiment, the control unit comprises a processor that is in communication with a memory. The processor manages the overall operation of the educational interactive teaching apparatus, coordinating the interactions between the interactive buttons and the audio unit. The memory, connected to the processor, is configured to store various phonetic data, including individual phonetic sounds for each alphabet, a plurality of phonetic sounds corresponding to different word families, and complete pronunciations of a variety of sight words.

In one embodiment, the on-broad power unit is configured to power the audio unit, and the control unit. In one embodiment, the on-broad power unit comprises, but is not limited to, a rechargeable battery, a solar power unit, and a removable battery cell.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1A illustrates a schematic view of an educational interactive teaching apparatus for literacy development and teaching phonics, in accordance with embodiments of the invention.

FIG. 1B illustrates a perspective view of the educational interactive teaching apparatus for literacy development and teaching phonics, in accordance with embodiments of the invention.

FIG. 2 illustrates a perspective view of another embodiment of the educational interactive teaching apparatus for literacy development and teaching phonics, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

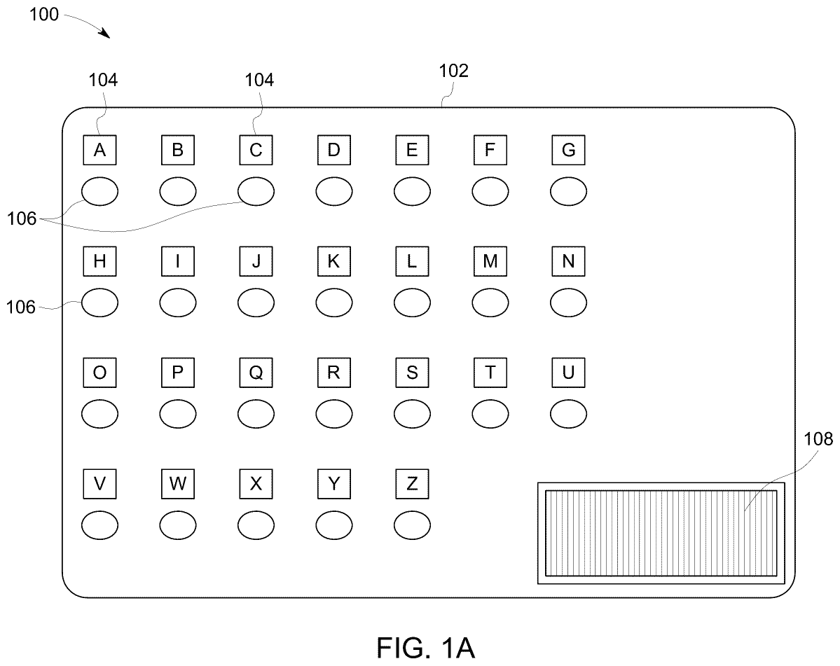

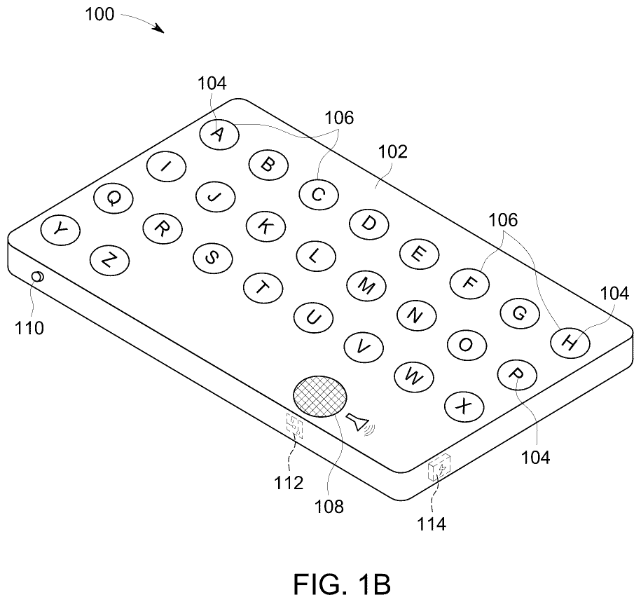

FIG. 1A refers to a schematic view of an educational interactive teaching apparatus 100 for literacy development and teaching phonics. The educational interactive teaching apparatus 100 comprises a body 102, a plurality of interactive buttons 106, an audio unit 108, a power switch 110, a control unit 112, and an on-broad power unit 114. The educational interactive teaching apparatus 100 is an eco-friendly and sustainable apparatus that facilitates learning of phonetic sounds, sight words, and word families.

FIG. 1B refers to a perspective view of the educational interactive teaching apparatus 100 for literacy development and teaching phonics. The body 102 is made of a biodegradable, strong, and eco-friendly material that comprises at least one of a wood, and cork.

In one embodiment, wood, known for its natural strength and durability, makes the educational interactive teaching apparatus 100 sturdy enough to withstand regular use by children. Its biodegradable nature ensures it decomposes harmlessly, and when sourced responsibly, it becomes a renewable and sustainable material. Additionally, wood can be treated with child-safe finishes for enhanced durability and aesthetic appeal.

In one embodiment, cork is lightweight, flexible, and shock-absorbent, providing added durability and safety. Its natural resistance to moisture and microbial growth ensures hygiene and longevity, while its soft texture reduces the risk of injuries, making it particularly suitable for children's products. Both materials offer a tactile, sensory-friendly experience that enhances engagement and aligns with the growing demand for sustainable, non-plastic alternatives. Together, wood and cork create a durable, child-safe, and environmentally conscious design, ensuring the educational interactive teaching apparatus 100 is both functional and sustainable.

In one embodiment, the body 102 is made of a material includes, but is not limited to, natural rubberwood, plastic, vinyl, fiber-glass, glass, and paperboard.

In one embodiment, the interactive buttons 106 is positioned on a top surface of the body 102. Each interactive button 106 is adapted to indicate at least one of an alphabet 104, a sight word, blends, digraphs, and a phonetic group, catering to various learning levels and objectives. The representation of each alphabet 104 on the interactive buttons 106 is implemented through printing, embossing, or engraving, offering flexibility in design while enhancing the tactile or visual experience. This multifunctional approach ensures that the interactive buttons 106 serve as both interactive and educational elements, enabling users to associate the physical interaction with phonetic learning effectively.

In one embodiment, the audio unit 108 is operatively connected to the interactive buttons 106. The audio unit 108 is configured to generate an auditory output corresponding to a phonetic sound of a selected alphabet 104, a selected sight word, or a selected phoneme when at least one interactive button 106 associated with the selected alphabet 104 is pressed. This functionality enables users to hear the accurate phonetic pronunciation immediately upon interaction, fostering a direct connection between the visual representation and its sound. By seamlessly integrating tactile interaction with auditory learning, this feature enhances user engagement and supports effective phonics and reading skill development.

In one embodiment, the audio unit 108 includes, but is not limited to, a speaker, which provides clear and precise sound output. This design enhances the educational experience by reinforcing phonetic associations through audible cues, making the learning process more engaging and effective.

In one embodiment, the power switch 110 is configured to control the activation and deactivation of the educational interactive teaching apparatus 100. When the power switch 110 is turned on, it initiates the operation of the educational interactive teaching apparatus 100, enabling the interactive buttons 106 and audio unit 108 to function as intended. Conversely, when the power switch 110 is turned off, it deactivates the educational interactive teaching apparatus 100, conserving energy and ensuring the educational interactive teaching apparatus 100 is not in use when not needed. This simple yet essential feature ensures easy control of the educational interactive teaching apparatus 100, providing convenience and efficiency for users.

In one embodiment, the control unit 112 is in communication with the audio unit 108 and the plurality of interactive buttons 106. When a user presses at least one interactive button 106, the control unit 112 activates the audio unit 108 to generate the corresponding auditory output, such as the phonetic sound of the selected alphabet 104 or sight word. Additionally, the control unit 112 is configured to detect when the user presses and holds an interactive button 106. This extended press triggers the generation of sound combinations, such as blends of vowels and consonants, corresponding to the selected alphabet 104 or phonetic group. This functionality enables more complex phonics and word-building exercises, enhancing the learning experience by facilitating the practice of word blending and phonemic awareness.

In another embodiment, the control unit 112 is configured to communicate with the audio unit 108 and the plurality of interactive buttons 106 via a communication path, ensuring coordination between the control unit 112, the audio unit 108, and the interactive buttons 106. The communication path of the educational interactive teaching apparatus 100 comprises, but is not limited to, both wireless and wired communication options. The wireless communication path may include networks comprise, but are not limited to, Bluetooth or Wi-Fi, enabling seamless and efficient data transfer without the need for physical connections. The wired communication path consists of a plurality of cables, which provide a direct and stable connection for data transfer and power supply.

In one embodiment, the control unit 112 comprises a processor that is in communication with a memory. The processor manages the overall operation of the educational interactive teaching apparatus 100, coordinating the interactions between the interactive buttons 106 and the audio unit 108. The memory is connected to the processor. The memory is configured to store various phonetic data, including individual phonetic sounds for each alphabet 104, a plurality of phonetic sounds corresponding to different word families, and complete pronunciations of a variety of sight words in a database. This stored data enables the control unit 112 to quickly retrieve and play the appropriate sound when at least one interactive button 106 is pressed, ensuring accurate and consistent auditory output for the user. By utilizing the memory for phonetic sounds and word pronunciations, the educational interactive teaching apparatus 100 provides a comprehensive learning experience, covering a wide range of phonics concepts, from individual alphabet 104 sounds to more complex word families and sight words.

In another embodiment, the control unit 112 is in communication with one or more external devices through a communication path. The communication path of the educational interactive teaching apparatus 100 comprises, but is not limited to, both wireless and wired communication options. The wireless communication path may include networks comprise, but are not limited to, Bluetooth or Wi-Fi, enabling seamless and efficient data transfer without the need for physical connections. This allows for convenient interaction with the external devices, such as smartphones, tablets, or computers, and can also support future updates or expansions of the database in the memory. The wired communication path consists of a plurality of cables, which provide a direct and stable connection for data transfer. This combination of wireless and wired communication paths ensures flexibility and reliability in connecting the apparatus to various external devices or networks, enhancing its functionality and usability in diverse settings.

In one embodiment, the on-broad power unit 114 is configured to power the audio unit 108, and the control unit 112. In one embodiment, the on-broad power unit 114 comprises, but is not limited to, a rechargeable battery, a solar power unit, and a removable battery cell. The rechargeable battery allows for convenient recharging, providing a sustainable power source for extended use. The solar power unit offers an eco-friendly alternative, allowing the apparatus to be charged through solar energy, ideal for outdoor or off-grid usage. The removable battery cell provides added flexibility, enabling users to replace or recharge batteries independently, further enhancing the educational interactive teaching apparatus's usability and longevity. This multi-option power system ensures that the educational interactive teaching apparatus 100 remains operational while minimizing the environmental impact and providing convenience for users.

In another embodiment, the on-broad power unit 114, which includes rechargeable and solar-powered options, ensures the educational interactive teaching apparatus 100 remains functional while minimizing its environmental footprint. Together, these features make the educational interactive teaching apparatus 100 an effective, safe, and sustainable tool for teaching literacy and phonics.

In another embodiment, the educational interactive teaching apparatus 100 offers several advantages that enhance both the learning experience and the sustainability of its design. First, the use of biodegradable, eco-friendly materials such as wood and cork ensures the educational interactive teaching apparatus 100 is both durable and environmentally responsible. Wood provides structural integrity, while cork's lightweight and shock-absorbent properties contribute to the safety and longevity of the product, making it ideal for use by children.

In another embodiment, the educational interactive teaching apparatus 100 is designed to engage users through the interactive buttons 106, which are tactile, each corresponding to the alphabets 104, sight words, blends, digraphs, and phonetic groups, thereby promoting a multisensory learning experience. The integrated audio unit 108 enhances this by providing immediate phonetic feedback, reinforcing the connection between visual and auditory learning. The control unit 112 allows for both simple and advanced phonics exercises, including sound combinations, thus fostering phonemic awareness and word-building skills.

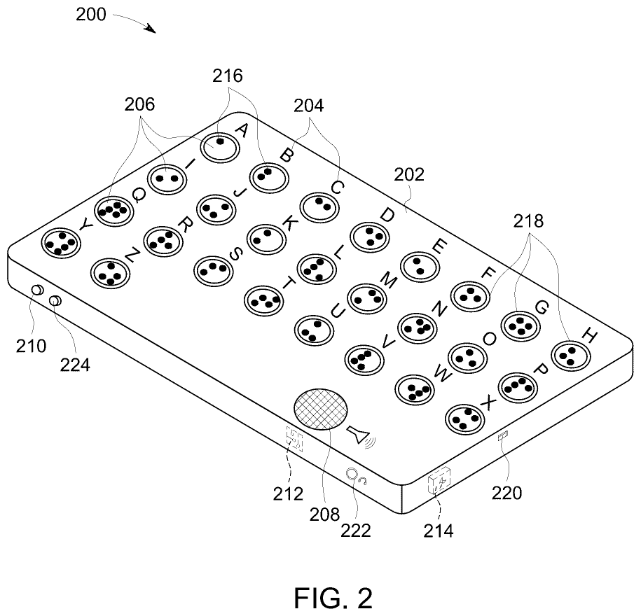

FIG. 2 refers to a perspective view of another embodiment of the educational interactive teaching apparatus 200 for literacy development and teaching phonics. The educational interactive teaching apparatus 200 comprises a body 202, a plurality of interactive buttons 206, an audio unit 208, a power switch 210, a control unit 212, and an on-broad power unit 214, braille 216, and a plurality of light-activated sensors 218.

In another embodiment, the interactive buttons 206 are positioned on a top surface of the body 202. Each interactive button 206 is adapted to indicate at least one of an alphabet 204, a sight word, blends, digraphs, and phonetic group. The audio unit 208 is operatively connected to the interactive buttons 206. The audio unit 208 is configured to generate an auditory output corresponding to a phonetic sound of a selected alphabet 204, a selected sight word, or a selected phoneme when at least one interactive button 206 is pressed.

In another embodiment, the control unit 212 is in communication with the audio unit 208 and the plurality of interactive buttons 206. The control unit 212 is configured to activate the audio unit 208 when the at least one interactive button 206 is pressed. The control unit 212 is configured to detect pressing and holding of the at least one interactive button 206 to trigger generation of sound combinations of vowels and consonants corresponding to the selected alphabet 204 or the phonetic group.

In another embodiment, the power switch 210 is configured to activate and deactivate the educational interactive teaching apparatus 200. A volume switch 224 is positioned on the body 202 of the educational interactive teaching apparatus 200. The volume switch 224 is configured to adjust the volume of the auditory output generated by the audio unit 208. This allows users to increase or decrease the sound level based on their preferences or the environment in which the educational interactive teaching apparatus 200 is being used. The volume switch 224 is configured to provide flexibility to ensure the auditory output is appropriately audible and comfortable for the user. This feature enhances the overall user experience by allowing for personalized sound control.

In another embodiment, at least one light-activated sensor 218 is positioned beneath each interactive button 206. These sensors are configured to detect both the pressing and holding of the interactive buttons 206, ensuring that the educational interactive teaching apparatus 200 responds accurately to user input. When the interactive button 206 is correctly pressed, the light-activated sensor 218 triggers the activation of corresponding lights, providing visual feedback to the user. This feature enhances the interactive experience by offering a clear, visual indication of correct button interaction, further engaging the user in the learning process. The light feedback also aids reinforce the connection between the tactile action of pressing the button and the auditory or visual output, promoting better understanding and retention of the phonetic sounds or words associated with the interactive button 206.

In another embodiment, the body 202 is configured with a socket port 222 that is configured to enable insertion of a head set jack. The socket port 222 is configured to allow users to connect a headset, which is configured to transmit the auditory output directly to the user. By using the headset jack, the user can listen to the phonetic sounds, sight words, or phoneme combinations in a private and focused manner, without external distractions. This feature is particularly useful in environments where quiet or individualized learning is preferred, or for users who may benefit from a more immersive auditory experience. The inclusion of the headset jack provides flexibility, allowing the educational interactive teaching apparatus 200 to be used in diverse settings while catering to different user preferences.

In another embodiment, the on-broad power unit 214 is configured to power the audio unit 208, and the control unit 212. The on-broad power unit 214 comprises, but is not limited to, a rechargeable battery, a solar power unit, and a removable battery cell. Further, the body 202 is equipped with a rechargeable port 220, which is configured to enable the user to recharge the on-board power unit 214. This port allows for convenient recharging of the educational interactive teaching apparatus 200, ensuring that the power unit remains functional for continued use. The rechargeable port 220 is compatible with standard charging cables or charging stations, providing an easy and efficient way to restore power to the educational interactive teaching apparatus 200. This feature enhances the sustainability and usability of the educational interactive teaching apparatus 200 by allowing the power source to be replenished without the need for replacing batteries, making it both eco-friendly and cost-effective for long-term use.

In one embodiment, the braille 216 representations of the alphabets 204 or words are incorporated into the educational interactive teaching apparatus 200 to facilitate accessibility for visually impaired users. These braille 216 representations are strategically placed on or near the interactive buttons 206, allowing users with visual impairments to feel and read the corresponding the alphabets 204 or words through tactile interaction. By integrating braille 216, the apparatus ensures inclusivity and provides a meaningful learning experience for individuals who rely on touch-based reading.

In another embodiment, unlike traditional methods that often rely on TV or computer screens, the educational interactive teaching apparatus 200 provides a tactile, hands-on learning experience. The interactive nature of the educational interactive teaching apparatus 200 allows children to press buttons corresponding to the alphabets 204, sight words, blends, digraphs, and phonetic families, and immediately hear the correct phonetic sound. This fosters independent learning and enhances phonemic awareness through auditory and tactile feedback.

In another embodiment, the wooden construction of the educational interactive teaching apparatus 200 contributes to its eco-friendly design, offering a green alternative to plastic-based toys and educational tools. The use of natural, biodegradable materials such as wood and cork ensures that the educational interactive teaching apparatus 200 is both durable and child-safe. Furthermore, the educational interactive teaching apparatus's design, coupled with its battery-operated functionality, provides a sustainable and portable learning solution that can be used without the need for screens or electricity.

This feature supports the development of literacy skills, making the educational tool more versatile and accessible to a broader range of learners. In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. An educational interactive teaching apparatus for literacy development and teaching phonics, comprising:
a body having a top surface, wherein the body defining a chamber;
a plurality of interactive buttons positioned on the top surface of the body, wherein each of the interactive button is adapted to indicate at least one of an alphabet, a sight word, blends, digraphs, and phonetic group;
an audio unit operatively connected to the plurality of interactive buttons, wherein the audio unit is configured to generate auditory outputs corresponding to a phonetic sound of at least one of a selected alphabet, a selected sight word, and a selected phoneme when at least one interactive button is pressed; and
a control unit in communication with the audio unit and the plurality of interactive buttons configured to:
activate the audio unit when the at least one interactive button is pressed, and
detect pressing and holding of the at least one interactive button to trigger generation of sound combinations of vowels and consonants as the auditory outputs corresponding to the selected alphabet or the phonetic groups.

2. The educational interactive teaching apparatus of claim 1, wherein the body is made of a biodegradable, strong, and eco-friendly material that comprises at least one of a wood, and cork.

3. The educational interactive teaching apparatus of claim 1, wherein the body is made of a material includes at least one of natural rubberwood, plastic, vinyl, fiber-glass, glass, and paperboard.

4. The educational interactive teaching apparatus of claim 1, wherein the body further comprises a power switch that is configured to activate and deactivate the educational interactive teaching apparatus.

5. The educational interactive teaching apparatus of claim 1, wherein the body houses an on-broad power unit, wherein the on-broad power unit is configured to power the audio unit, and the control unit.

6. The educational interactive teaching apparatus of claim 1, wherein the control unit comprises:
a processor in communication with a memory, wherein the memory is configured to store individual phonetic sounds for each alphabet, plurality of phonetic sounds for a plurality of word families, and complete pronunciations of a plurality of sight words.

7. The educational interactive teaching apparatus of claim 1, wherein the educational interactive teaching apparatus comprises at least one light-activated sensor that is positioned beneath each interactive button, wherein the at least one light-activated sensor is configured to detect pressing and holding of the plurality of interactive buttons and activate corresponding lights when correctly pressed.

8. The educational interactive teaching apparatus of claim 1, wherein each of the alphabet is either printed or embossed or engraved on a respective interactive button.

9. An educational interactive teaching apparatus for literacy development and teaching phonics, comprising:
a body made of a wood having a top surface;
a plurality of interactive buttons positioned on the top surface of the body, wherein each of the interactive button is adapted to indicate at least one of an alphabet, a sight word, blends, digraphs, and phonetic group;
an audio unit operatively connected to the plurality of interactive buttons, wherein the audio unit is configured to generate auditory outputs corresponding to a phonetic sound of a selected alphabet, a selected sight word, and a selected phoneme when at least one interactive button is pressed; and
a control unit in communication with the audio unit and the plurality of interactive buttons, wherein the control unit is configured to:
activate the audio unit when the at least one interactive button is pressed, and
detect pressing and holding of the at least one interactive button to trigger generation of sound combinations of vowels and consonants corresponding to the selected alphabet or the phonetic group.

10. The educational interactive teaching apparatus of claim 9, wherein the body further comprises a power switch that is configured to activate and deactivate the educational interactive teaching apparatus.

11. The educational interactive teaching apparatus of claim 9, wherein the body houses an on-broad power unit, wherein the on-broad power unit is configured to power the audio unit, and the control unit.

12. The educational interactive teaching apparatus of claim 9, wherein the control unit comprises:
a processor in communication with a memory, wherein the memory is configured to store individual phonetic sounds for each alphabet, plurality of phonetic sounds for a plurality of word families, and complete pronunciations of a plurality of sight words.

13. The educational interactive teaching apparatus of claim 9, wherein the educational interactive teaching apparatus comprises at least one light-activated sensor that is positioned beneath each of the interactive button, wherein the at least one light-activated sensor is configured to detect pressing and holding of the plurality of interactive buttons and activate corresponding lights when correctly pressed.

14. The educational interactive teaching apparatus of claim 9, wherein each of the alphabet is either printed or embossed or engraved on a respective interactive button.

15. A method for operating an educational interactive teaching apparatus, comprising:
activating, by a user, the educational interactive teaching apparatus by pressing a power switch;
pressing, by the user, one or more interactive buttons; and
enabling, by an audio unit, to generate an auditory output corresponding to a phonetic sound of a selected alphabet, a selected sight word, or a selected phoneme when the one or more interactive buttons are pressed.
